(19) United States
(12) Patent Application Publication
(10) Pub. No.: US 2007/0277016 A1
(43) Pub. Date: Nov. 29, 2007

(54) Methods and apparatus related to memory modules

(76) Inventor: Gerhard Risse, Munchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/441,630

(22) Filed: May 27, 2006

(51) Int. Cl. G06F 12/00

(52) U.S. Cl. 711/170

(57) ABSTRACT

A control unit for a memory module includes a usage determination unit configured to determine accumulated usage information and a control circuit coupled to the usage determination unit. The control circuit is configured to compare the accumulated usage information and usage limit information defining a limit for a usage of the memory module, and to control the operation of the control unit based on a result of the comparison.

### BACKGROUND

Modern high-end servers provide memory capacities which, even at present, may exceed several tens of Gigabytes or even hundred Gigabytes. Costs associated with the memory modules that are required to provide such large memory capacities have become a significant cost factor for servers, and prices for servers have increased with increasing memory capacities. From a user's point of view, large memory capacities are a significant cost factor when purchasing a server system.

At the same time, prices for memory modules, such as fully buffered dual in-line memory modules (fully buffered DIMMs or FB-DIMMs), are subject to price fluctuations, giving rise to corresponding fluctuations of sale revenues experienced by manufacturers of memory modules. A further problem faced by both memory module manufactures and server manufacturers is that memory modules, such as DIMMs, may be copied by competitors which, subsequently, enter the memory upgrade market and compete against original equipment manufacturers (OEMs).

For these and other reasons, there is a need for the present invention.

### SUMMARY

One embodiment provides a control unit for a memory module. The control unit includes a usage determination unit configured to determine accumulated usage information. The control unit includes a control circuit coupled to the usage determination unit. The control circuit is configured to compare the accumulated usage information and usage limit information defining a limit for a usage of the memory module. The control circuit is configured to control the operation of the control unit based on a result of the comparison.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a schematic representation which serves to illustrate a method for leasing a memory module according to an embodiment.

FIG. 2 is a schematic representation of a memory unit according to an embodiment.

FIGS. 3A and 3B are flow charts schematically illustrating methods for operating a memory module according to embodiments.

FIG. 4 is a flow chart illustrating a process for extending a usage limit in a method for operating a memory module according to an embodiment.

FIG. 5 schematically illustrates information transmitted between a lessor's server and a lessee's computer in a method for leasing a memory module according to an embodiment.

FIG. 6 schematically illustrates information transmitted between a lessor's server and a lessee's computer in a method for leasing a memory module according to an embodiment.

FIG. 7 is a schematic representation of a control unit for a memory module according to an embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

One embodiment of a control unit for a memory module comprises a usage determination unit to determine an accumulated usage information and a control circuit coupled to the usage determination unit to compare the accumulated usage information and a usage limit information that defines a limit for usage of the memory module. The control circuit controls the operation of the control unit based on a result of the comparison of the accumulated usage information and the usage limit information.

One embodiment of a memory module comprises a control unit including a usage limit storage unit to store a usage limit information and a usage determination unit to determine an accumulated usage information, and at least one memory chip coupled to the control unit, wherein the control unit compares the usage limit information and the accumulated usage information and controls the memory module so that data are not further stored in the at least one memory chip if the accumulated usage information reaches the usage limit information.

One embodiment of a method for operating a memory module comprises retrieving an accumulated usage information, comparing the accumulated usage information and a usage limit information, receiving data to be stored, and storing the data in the memory module based on a result of the comparing.

One embodiment of a method for leasing a memory module comprises providing the memory module to a lessee for usage in a computer and monitoring an accumulated usage of the memory module. A lease fee is determined based on the accumulated usage.

One embodiment of a memory module has a storage functionality that may be at least partially disabled if a pre-determined accumulated usage limit (e.g., a pre-determined maximum usage time) has been reached.

One embodiment of a memory module is leased. The lease fee or pay is determined based on an actual usage of the memory module, such as usage time, so that lease fees generate a stable and continuous source of income for lessor.

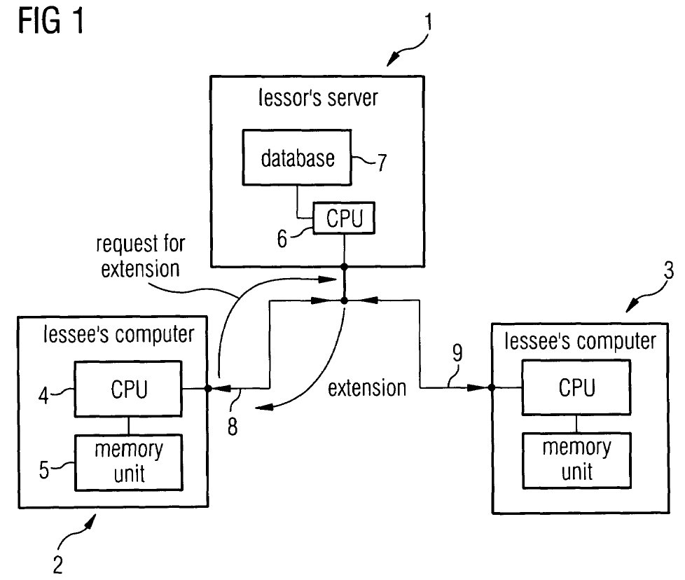

A method of leasing a memory module according to an embodiment is explained with reference to FIG. 1. FIG. 1 schematically illustrates lessor's server 1, to which a plurality of computers 2, 3 are connected via data transfer connections 8, 9. It is to be understood that, while the term “computer” will be used throughout with reference to lessee's computer system, this computer may be a server.

Lessee's computer 2 includes a central processing unit (CPU) 4 and a memory unit 5 connected thereto. As will be explained in more detail below, the memory unit 5 comprises one or several memory modules leased from lessor, which are configured in such a way that a storage functionality of the leased memory module or of the leased memory modules is at least partially disabled if a usage limit (e.g., an operation time) is exceeded. In order to avoid such a disabling of storage functionality, in an embodiment, lessee's computer automatically requests an extension of the usage limit by transmitting a corresponding request to lessor's server via data transfer connection 8 when the current usage limit is approached.

The memory modules are provided to lessee by lessor or an associate of lessor, either directly or via a manufacturer of the computers 2, 3. While the leased memory modules are physically installed in lessee's computer, their configuration, as described above, ensures that lessee must regularly contact lessor for receiving a usage extension, thus allowing lessor to charge a lease fee based on an actual usage of the leased memory modules.

Lessor's server includes a CPU 6 and a database 7 coupled thereto, the database containing data relating to memory modules leased from lessor, such as a unique identifier for each module leased and information on one or several usage extensions previously granted.

When receiving the request for usage extension, lessor's server automatically generates an extension signal that is transmitted to lessee's computer via data transfer connection 8. As will be explained in more detail below, the leased memory modules comprised by the memory unit 5 are configured such that the usage limit of a memory module may be extended by inputting an appropriate extension signal or extension code thereto. Therefore, by inputting the extension signal provided by lessor's server to the memory module installed in lessee's computer, the usage of the memory module may be extended (i.e., the lease of the memory module is extended). At the same time, the provision of the extension signal, and the amount by which the usage limit is extended, is registered in the database 7 of lessor's server, thus allowing lessor to charge lessee for the usage extension granted.

While the data transfer connections 8, 9 are schematically illustrated as physical links in FIG. 1, the data transfer connections may be any other suitable connection, such as a wireless data connection. In particular, the data transfer connection connecting lessee's computer and lessor's server do not need to be special purpose data connections. Rather, the request for extension and the extension signal may be transmitted between lessor's server and lessee's computer via an arbitrary network or the internet if both lessor's server and lessee's computer are connected thereto.

Further, while, in the embodiment shown in FIG. 1, the request for extension is generated automatically by lessee's computer and the extension signal is generated automatically by lessor's server when receiving the request, in alternative embodiments, the extension signal may be input to lessee's computer in any other suitable way. For example, lessee may contact lessor by telephone, requesting a usage extension, lessor may provide the extension signal by telephone, and lessee may manually input the extension signal into his/her computer, the signal being transmitted to the memory module for extending the lease.

Finally, while only two computers having leased memory modules installed therein are shown to be connected to lessor's server in FIG. 1, it is to be understood, that an arbitrary number of computers having leased memory modules installed therein may be connected to lessor's server and may be operated as explained above with reference to lessee's computer 2.

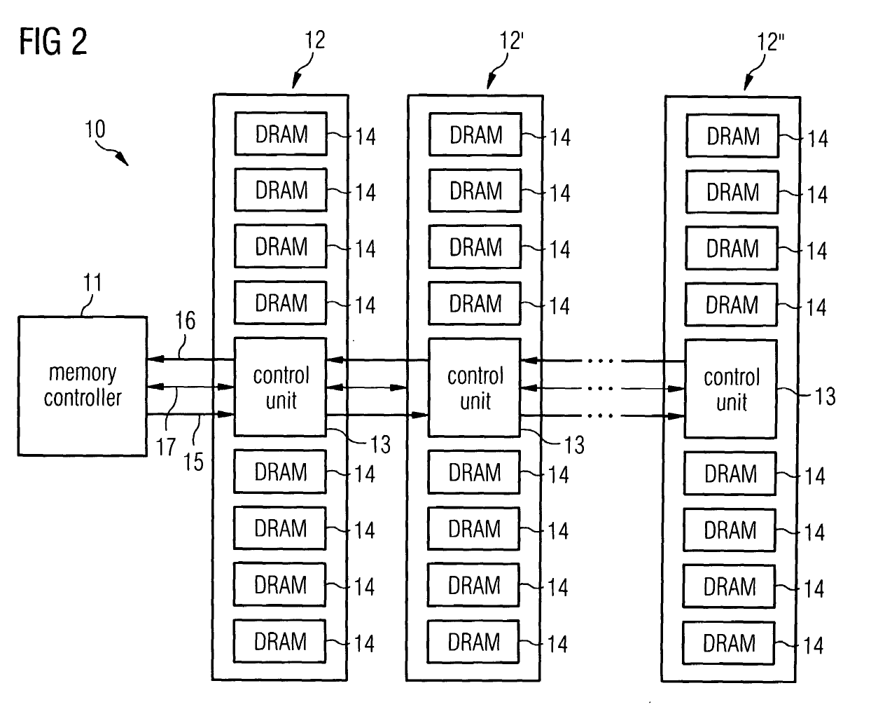

A memory unit 10 according to an embodiment is illustrated in FIG. 2. The memory unit 10 may be used as memory unit 5 in lessee's computer 2 illustrated in FIG. 1.

The memory unit 10 comprises a plurality of memory modules 12, 12′, 12″, each of which comprises a plurality of memory chips 14 (e.g., DRAM memory chips) installed thereon. Each memory module 12, 12′, 12″ further comprises a control unit 13 connected to the plurality of memory chips 14 comprised by the respective memory module 12, 12′, 12″. The memory modules 12, 12′, 12″ form a series or daisy chain configuration, a first memory module 12 being connected to a memory controller 11.

Two channels 15, 16 with typically high data transfer rates are provided for data transfer from the memory controller 11 to the memory modules 12, 12′, 12″ and vice versa, respectively. Additionally, an SMBus 17 is provided that typically is used for various control functions. Data transferred via channel 15, which comprises a storage address information identifying a storage address in one of the memory modules, is first buffered by the control units 13 of the memory modules 12, 12′, 12″ and, after the control units 13 have determined whether the storage address corresponds to the respective memory module, is stored in a memory chip of the respective memory module.

Examples of memory modules 12, 12′, 12″ are fully buffered DIMM (FB-DIMM), FB-DIMM2, or other memory modules having a serial buffer. While only three memory modules 12, 12′ and 12″ are illustrated in FIG. 2, the number of memory modules may be any arbitrary suitable number.

While the control units 13 of the memory modules 12, 12′, 12″ buffer data in a way identical or similar to a conventional advanced memory buffer (AMB), in an embodiment, the control units 13 are configured in such a way as to perform additional functions specifically directed at monitoring an accumulated usage of the memory module and, if the accumulated usage exceeds a usage limit stored on the control unit 13, disabling, at least in part, a storage functionality of the memory module.

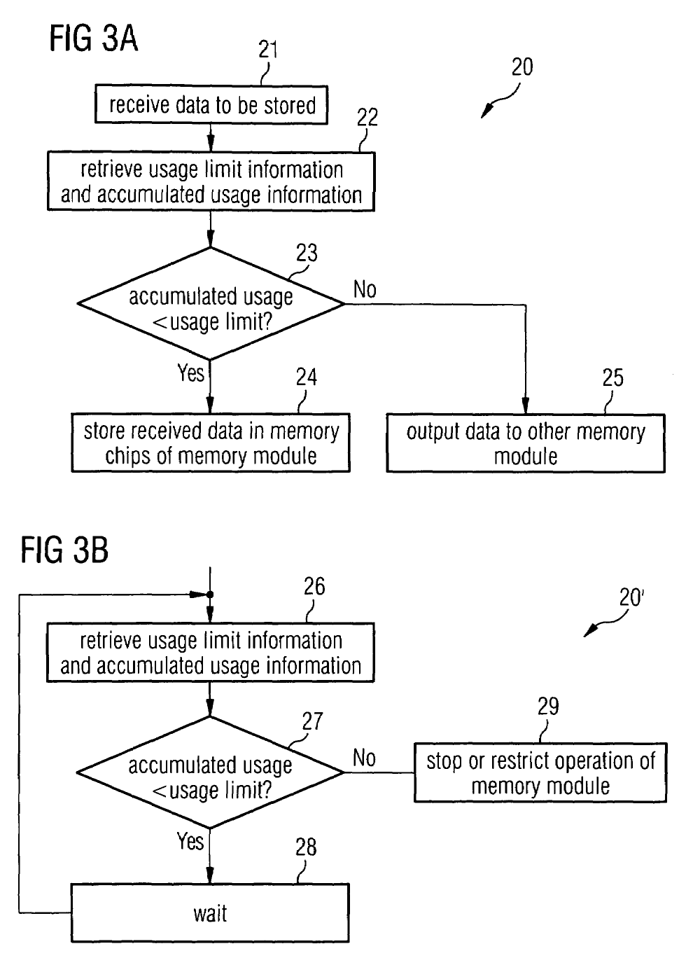

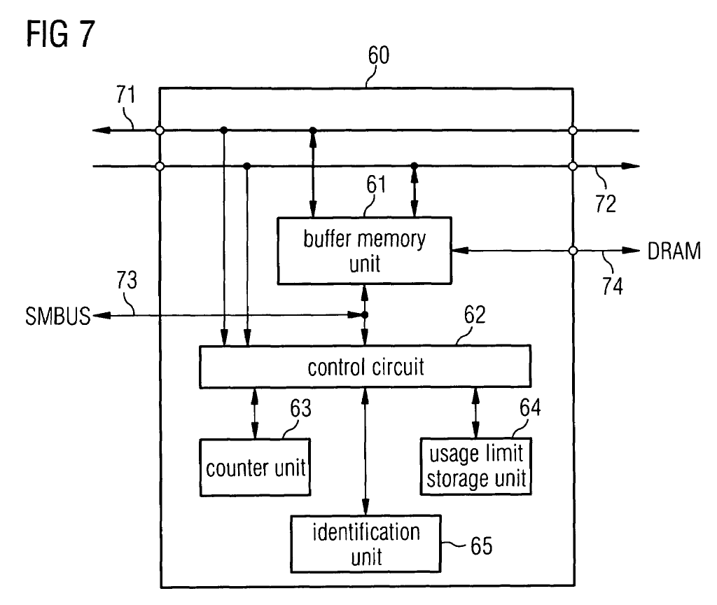

An embodiment of a method 20 of operating memory modules 12, 12′, 12″ is illustrated in FIG. 3A. FIG. 3A schematically illustrates how data received by the memory module 12, 12′, 12″ is processed. The various acts or steps of the method 20 may be performed by the control unit 13 of the respective memory module or by the CPU of the computer in which the memory module is installed, or some acts or steps may be performed by the control unit and other acts or steps may be performed by the CPU. While a construction of one embodiment of a control unit will be more fully described with reference to FIG. 7 below, it is noted here that control unit 13 has stored thereon a usage limit information and comprises a usage determination unit (e.g., in the form of a counter unit), determining and storing an accumulated usage of the memory module. The usage limit may be, for example, a total operation time of the memory module or a total maximum amount of data stored in the memory module over time. Correspondingly, the accumulated usage may correspond, for example, to an accumulated operation time or an accumulated amount of data stored in the memory module.

In one embodiment, after the control unit 13 has received, at 21, data to be stored from the memory controller 11 via channel 15, at 22, the usage limit information and the accumulated usage information are retrieved and are compared at 23. These acts or steps may be performed by the control unit 13 of the memory module. Alternatively, these acts or steps may be performed by the CPU of the computer in which the memory module is installed, and a signal may be sent from the CPU to the control unit 13 in dependence on the result of the comparison at 23. Still further, these acts or steps do not need to be performed each time data are received. Rather, in embodiments, these acts or steps are only performed, for example, in regular time intervals or each time pre-determined data amounts have been received, as will be described in more detail with reference to FIG. 3B below.

Assuming, for simplicity, that the storage address information of the data received corresponds to an address on the memory module controlled by the control unit 13, the received data is stored in one or several of the memory chips of the memory module at 24, if the accumulated usage does not exceed the usage limit. By contrast, if the accumulated usage exceeds the usage limit (i.e., once the accumulated usage has reached the usage limit) the received data is not stored in the memory module, thus disabling the storage functionality of the memory module. Various actions may be taken if the accumulated usage exceeds the usage limit. In the embodiment illustrated in FIG. 3A, at 25, the received data is output via one of channels 15, 16 to another memory module of the memory unit. This may be performed in various ways, such as by the control unit 13 transmitting a corresponding signal to the memory controller 11, the signal indicating that the usage limit is exceeded, whereupon the memory controller 11 provides a new storage address to the control unit 13, which in turn outputs the received data with the new storage address to one of channels 15, 16. Alternatively, the control unit 13 may output the data to the memory controller 11 via channel 16, the control unit then providing the data with a new storage address information and re-transmitting the data via channel 15 to another memory module, the usage limit of which is not yet exceeded.

In one embodiment, once the accumulated usage exceeds the usage limit, the control unit 13 sends a corresponding signal to the memory controller 11, so that the memory controller 11 no longer addresses data to this memory module.

In one embodiment, once the usage limit is exceeded, the control unit of the respective memory module is fully switched off, thereby cutting the series configuration illustrated in FIG. 2 into halves.

As already indicated above, FIG. 3A schematically illustrates how data are processed in the memory module. A method 20′ for operating a memory module according to one embodiment is illustrated in FIG. 3B. The acts or steps of method 20′ are performed in parallel to other operation acts or steps of a memory module, which may include buffering data and storing data. Again, the acts or steps of method 20′ may be performed by the control unit 13, or by the CPU of the computer in which the memory module is installed, or a part of the acts or steps may be performed by the control unit 13 while another part is performed by the CPU.

At 26, the usage limit information and accumulated usage information are retrieved and are subsequently compared at 27. If the accumulated usage has not yet reached or exceeded the usage limit, after a wait time at 28, acts or steps 26 and 27 are repeated. By contrast, if the accumulated usage has reached the usage limit, at 28, the operation of the memory module will be stopped or a storage functionality thereof will be restricted at 29.

As already indicated above, the operation of the memory module may be restricted in a number of ways. For example, any access to the memory chips 14 may be inhibited. Alternatively, only the write access to the memory chips 14 will be inhibited and an error command is output by the control unit if a write command is received. Various other implementations of act or step 29 are conceivable. In one embodiment, once the operation of the memory module is stopped or restricted at 29, acts or steps 26 and 27 do not have to be carried out until the usage limit is increased.

While situations may occur in which the accumulated usage indeed exceeds the usage limit and a storage functionality of the memory module is disabled, it is typically in the interest of both lessor and lessee to regularly extend the usage limit of the memory module, thereby extending the lease of the memory module.

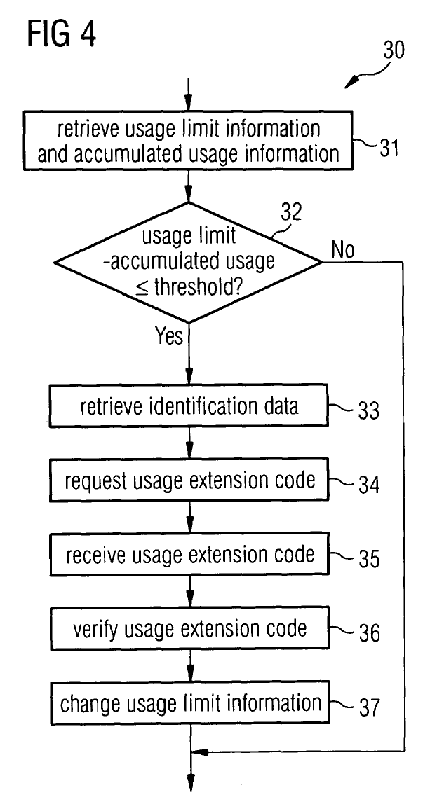

One embodiment of a method 30 for extending the usage limit is illustrated in FIG. 4. Again, unless otherwise noted, the various acts or steps of method 30 may be performed by either one of the control unit 13 or the CPU of the computer in which the memory module is installed. Method 30 may be performed, for example, at regular time intervals or whenever it is determined whether the accrued usage has reached the usage limit (i.e., before acts or step 23 in FIG. 3A and before act or step 27 in FIG. 3B).

At 31, the usage limit information and accumulated usage information are retrieved. At 32, the difference of the usage limit and the accumulated usage is compared to a pre-determined, appropriately selected threshold. In one embodiment, the threshold may be set to zero. In another embodiment, the threshold has a finite value which is selected so as to be sufficiently large that the usage limit may conveniently be extended before the usage limit is reached or exceeded. If the usage limit is still larger than the accumulated usage plus the threshold, no further action is taken. If however, the accumulated usage has approached the usage limit so as to be larger than the usage limit minus the threshold, acts or steps 33-37 are performed to extend the usage limit.

At 33, an identification information identifying the control unit 13 or the corresponding memory module is retrieved. The identification information is, in one embodiment, stored on the control unit and comprises a unique identifier identifying the control unit, hereinafter referred to as unique AMB ID (UAID). Next, at 34, the control unit 13 transmits a signal to the memory controller 11, either via channel 16 or SMBus 17, which signal indicates that a usage extension is required, the signal typically comprising or being based on the identification information retrieved in act or step 33.

Based on the request, the memory controller 11 may then output a corresponding information to a user or system administrator of the computer in which the leased memory module is installed, and an extension code is manually input into the computer. However, in the embodiment schematically illustrated in FIG. 1 and explained in detail above, the request for usage extension is automatically transmitted, suitably encoded, to lessor's server via a data transfer connection, and a usage extension code is automatically returned therefrom. For this purpose, in one embodiment, the BIOS or operating system of the computer in which the leased memory module is installed receives a respective information from the memory controller 11 that a usage extension is required and, in turn, requests a usage extension code from lessor's server. The usage extension code is then provided to the memory module.

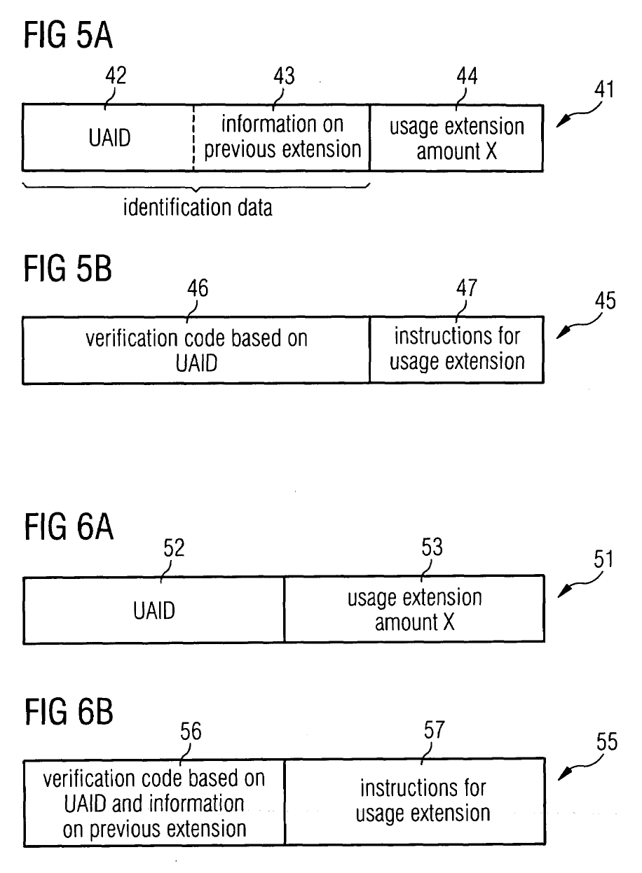

At 35, the usage extension code is received by the control unit. As will be explained in more detail with reference to FIGS. 5 and 6 below, the usage extension code comprises instructions for extending the usage limit in a suitably encoded form in order to prevent tampering and unauthorized extension of the lease by third parties other than lessor. Therefore, at 36, the usage extension code is verified or decoded. Only if the usage extension code is successfully verified or decoded, at 37, the control unit 13 changes the usage limit information in such a way that the usage limit is increased by an amount that is specified by the usage extension code.

While most of the acts or steps 31-37 may be performed by either one of the control unit 13 or the CPU, acts or steps 35-37 being performed by the control unit 13 enhances security. In one embodiment, acts or steps 31-34 are performed by the CPU, while acts or steps 35-37 are performed by the control unit 13.

While, in the embodiment explained with reference to FIG. 4 above, a usage extension is requested only when the accumulated usage approaches the usage limit, in another embodiment, acts or steps 33-37 may be performed irrespective of whether the usage limit is approached (e.g., in regular time intervals).

Next, with reference to FIGS. 5 and 6, information transmitted from and to the control unit 13 for extending the usage limit will be explained in more detail. In the embodiments of control units that employ the information schematically illustrated in FIGS. 5 and 6, respectively, the identifying information stored on the control unit does not only comprise the UAID, but additionally comprises information on at least one previous usage extension.

In the embodiment of FIG. 5, the information 41 transmitted from the control unit 13 of the memory module to lessor, illustrated in FIG. 5(A), comprises the UAID 42 and the information 43 on at least one previous usage extension, possibly supplemented by data 44 specifying the amount by which the usage limit is to be extended. The information on the previous usage extension may comprise, for example, information on an amount by which the usage limit has previously been extended, information on the date and/or time of a previous usage extension, or any other suitable information of this type. As schematically illustrated in FIG. 1, lessor typically operates a database containing information on previous updates for individual memory modules. When receiving the information illustrated in FIG. 5(A), the information 43 on at least one previous usage extension is compared to the information stored in the database for the memory module having UAID 42. Only if the information transmitted from the memory module and the information stored in lessor's database are consistent (e.g., if the amounts of the previous usage extension coincide) a usage extension code is transmitted to lessee. This usage extension code 45, schematically illustrated in FIG. 5(B), comprises a verification code 46 that is determined based on the UAID and instructions for usage extension 47. The verification code 46 is generated in such a way that it may be verified by the control unit 13 of the memory module which is identified by the UAID on which the verification code 46 is based. For example, assuming that the UAID is a numerical value, lessor may generate the verification code by inputting the UAID into an algorithm computing a specific function, such as a high polynomial, while the control unit may verify the verification code by computing the inverse function and comparing the result with the UAID stored on the control unit. However, any other suitable method for providing a verification code and for verifying the extension code may be employed with equal facility. After verification of the usage extension code based on the verification code 46, the control unit 13 updates the usage limit information in accordance with the instructions 47.

In the embodiment of FIG. 6, the information 51 transmitted from the control unit 13 of the memory module to lessor, illustrated in FIG. 6(A), comprises the UAID 52 and, possibly, data 53 specifying the amount by which the usage limit is to be extended. In contrast to the embodiment of FIG. 5, in the embodiment of FIG. 6, the information on at least one previous usage extension is not transmitted to lessor. Lessor retrieves information on a previous usage extension stored in the lessor's database and generates a verification code that is based on both the UAID and the information on the previous update retrieved from lessor's database. This verification code 56 is comprised by the information 55 transmitted to the control unit 13, schematically illustrated in FIG. 6(B), which information 55 further comprises instructions 57 for the usage extension. The control unit 13 verifies the verification code 56 by retrieving both the UAID and the information on the previous usage extension therefrom, employing a suitable algorithm, and by subsequently comparing both the UAID and the information on the previous usage extension with the information stored on the control unit 13. If the verification is successful, the usage limit is extended according to the instruction 57.

One embodiment of a control unit 60 for a memory module is illustrated in FIG. 7. The control unit 60 comprises a buffer memory unit 61 for buffering data and a control circuit 62 coupled thereto. The control unit 60 further comprises a usage determination unit (e.g., in the form of a counter unit 63) for determining and storing an accumulated usage information, a usage limit storage unit 64 (e.g., in the form of a special purpose storage unit provided in the control unit) for storing a usage limit information, and an identification unit 65 for storing identification information (e.g., in the form of a UAID and information on a previous usage extension) as already indicated above. The counter unit 63, the usage limit storage unit 64, and the identification unit 65 are each coupled to the control circuit 62 so as to provide data thereto and to receive data therefrom. In a simple case, the accumulated usage information and usage limit information may be numerical values directly corresponding to the accumulated usage and the usage limit. However, the accumulated usage and usage limit may be encoded as the accumulated usage information and usage limit information, respectively, in any other suitable way.

Both the buffer memory unit 61 and the control circuit 62 are coupled to channels 71, 72 and an SMBus 73. An additional channel 74 serves to couple the buffer memory unit to one or several DRAMs of a memory unit. The control unit 60 may, for example, be employed as control unit 13 for memory modules 12, 12′, and 12″ in FIG. 2, in which case channels 71, 72 and SMBus 73 similar to channels 15, 16 and SMBus 17, respectively.

The control circuit 62 is configured to perform the methods for operating a memory module and for extending the usage limit explained with reference to FIGS. 3 and 4 above, respectively. For this purpose, the control circuit retrieves the accumulated usage information and the usage limit information from the counter unit 63 and the usage limit storage unit 64, respectively, in the method for operating a memory module, and the identification information stored in the identification unit 65 in the method for extending the usage limit.

Since, in the embodiment illustrated in FIG. 7, the control circuit is coupled to both channels 71, 72 and SMBus 73, a request for a usage extension may be transmitted from the control unit 60 to a memory controller either via one of channels 71, 72 or via SMBus 73. Similarly, the extension code may be transmitted to the control unit 60 either via one of channels 71, 72 or via SMBus 73.

The usage determination unit or counter unit may be configured in any way which is suitable for determining the accumulated usage, based on the quantity which has been agreed on as a basis for the lease fee. For example, if the lease fee is determined on the basis of usage time, the counter circuit receives information on a clock rate frequency of the control unit from the control circuit and determines the accumulated usage time by counting clock cycles divided by clock rate frequency. If the lease fee is determined on the basis of a storage amount, the counter unit receives, from the control circuit 62, information on the size and number of data packets output from the buffer memory unit 61 via channel 74, and determines the total storage amount by adding the sizes of data packets stored in memory chips of the memory module. The counter unit 63 comprises a non-volatile storage unit in which the accumulated usage information is stored and maintained, even if the computer is switched off.

The control circuit 62 is further configured such that, while data may always be read from the usage limit storage unit 64 and the identification unit 65, data stored in the usage limit storage unit 64 and the identification unit 65 is typically only updated after a received usage extension code has been successfully verified. In this case, the usage limit information stored in the usage limit storage unit 64 will be update so as to correspond to the extended usage limit, and the information on at least one previous usage extension stored in the identification unit 65 will be updated in accordance with the latest usage extension.

Further, while the counter unit 63 and the usage limit storage unit 64 are illustrated as separate units in FIG. 7, these elements may be integrally formed. For example, in one embodiment, the counter unit may be designed as a “usage account,” to which usage extensions are credited, and to which any usage of the memory module is debited by continuously subtracting usage incurred (i.e., by counting backwards). In this case, when the counter reaches zero, the usage limit is reached and a usage extension must be requested, which is directly credited to the usage account by increasing the counter value in accordance with the received usage extension signal.

In one embodiment, the control unit 60 comprises a counter unit 63 and a usage limit storage unit 64 and, upon receiving a usage extension code, decreases the accumulated usage information stored in the counter unit 63 by resetting the counter or by reducing the counter value by subtracting the received usage extension therefrom, and leaves the usage limit information stored in the usage limit storage unit unchanged.

Many other variations of the embodiments described above are conceivable. For example, while a memory unit 10 has been described as being comprised by a set of identical memory modules, each including a control unit operative so as to disable, at least in part, a storage functionality of the respective memory module when a usage limit is exceeded, it is to be understood that memory modules, which are bought from a vendor, and memory modules which are leased from a lessor may be combined in a single memory unit.

While embodiments of control units has been described above as comprising a counter unit and a usage limit storage unit, the counter unit and usage limit storage unit could, in other embodiments, also be provided externally of the control unit.

While the embodiments of memory units have been described above as a series configuration of memory modules, other embodiments are implemented with memory units having other configurations or to memory units comprising a single memory module.

Further, while the some of the above embodiments have been described with reference to specific embodiments, it is to be understood that, unless specifically noted otherwise, features of the various embodiments may be suitably combined with one another.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A control unit for a memory module, comprising:
a usage determination unit configured to determine accumulated usage information; and
a control circuit coupled to the usage determination unit, configured to compare the accumulated usage information and usage limit information defining a limit for a usage of the memory module, and configured to control the operation of the control unit based on a result of the comparison.

2. The control unit according to claim 1, comprising:
a usage limit storage unit configured to store the usage limit information; and
wherein the control circuit is coupled to the usage limit storage unit and configured to retrieve the stored usage limit information.

3. The control unit according to claim 1, wherein the control circuit comprises an input configured to receive a usage extension signal defining an extension of the limit for a usage of the memory module, and the control circuit is configured to change the usage limit information based on the usage extension signal.

4. The control unit according to claim 3, comprising:
an identification unit configured to store identification information identifying the control unit; and
wherein the control circuit is configured to perform a verification of the usage extension signal based on the identification information and configured to change the usage limit information based on a result of the verification.

5. The control unit according to claim 4,
wherein the identification unit is configured to store information on at least one previous change of the usage limit information; and
wherein the control circuit is configured to perform the verification of the usage extension signal based on the information on at least one previous change of the usage limit information.

6. The control unit according to claim 1, wherein the control circuit comprises an input configured to receive a usage extension signal, and the control circuit is configured to change the accumulated usage information based on the usage extension signal.

7. The control unit according to claim 1, comprising:
a buffer memory unit; and
a data output configured to be coupled to a further memory module;
wherein the control circuit is configured to control the buffer memory unit so that, based on the result of the comparison, data buffered by the buffer memory unit is output through the data output and deleted from the buffer memory unit.

8. The control unit according to claim 1, wherein the usage determination unit is a counter unit configured to count an accumulated operation time of the memory module.

9. The control unit according to claim 1, wherein the control unit is an integrated circuit.

10. A memory module, comprising:
at least one memory chip configured to store data; and
a control unit coupled to the at least one memory chip and comprising:
a usage limit storage unit configured to store usage limit information; and
a usage determination unit configured to determine accumulated usage information;
wherein the control unit is configured to compare the usage limit information and the accumulated usage information and to control the memory module so that, if the accumulated usage information reaches the usage limit information, data is not further stored in the at least one memory chip.

11. The memory module according to claim 10,
wherein the control unit includes a buffer memory unit, and if the accumulated usage information reaches the usage limit information, the control unit does not output data buffered by the buffer memory unit to the at least one memory chip.

12. The memory module according to claim 11, wherein the buffer memory unit has a data output configured to be coupled to a further memory module, and the control unit is configured to output the data buffered by the buffer memory through the data output if the accumulated usage information reaches the usage limit information.

13. The memory module according to claim 10, wherein the usage determination unit is configured to determine the accumulated usage information from a data amount which is output from the control unit to the at least one memory chip.

14. The memory module according to claim 10, wherein the accumulated usage information comprises an operation time of the memory module.

15. The memory module according to claim 10, wherein the control unit comprises an input configured to receive a usage extension signal, and the control unit is configured to change the usage limit information based on the usage extension signal.

16. The memory module according to claim 10, wherein the memory module is a dual in-line memory module.

17. The memory module according to claim 16, wherein the control unit comprises an advanced memory buffer (AMB) of the memory module.

18. A memory module, comprising;
means for storing data received by the memory module;
means for retrieving usage limit information and accumulated usage information; and
means for determining, based on the usage limit information and the accumulated usage information, whether the received data is to be stored in the means for storing.

19. The memory module according to claim 18, comprising:
means for changing the usage limit information.

20. The memory module according to claim 19, wherein the means for changing the usage limit information comprises:
means for receiving a usage extension signal; and
means for verifying the usage extension signal prior to changing the usage limit information.

21. A method of operating a memory module, comprising:
retrieving accumulated usage information;
comparing the accumulated usage information and usage limit information;
receiving data to be stored; and
storing the data in the memory module based on a result of the comparing.

22. The method according to claim 21, comprising:
receiving a usage extension signal; and
changing the usage limit information based on the usage extension signal.

23. The method according to claim 22, comprising:
retrieving identification information identifying the memory module; and
verifying the usage extension signal based on the identification information.

24. The method according to claim 22, comprising:
determining whether a difference of the usage limit information and the accumulated usage information is below a pre-determined threshold; and
requesting the usage extension signal is based on a result of the determining.

25. A method of leasing a memory module, comprising:
providing the memory module to a lessee for usage in a computer;
monitoring an accumulated usage of the memory module; and
determining a lease fee based on the accumulated usage.

26. The method according to claim 25, wherein the monitoring the accumulated usage is performed by the memory module.

27. The method according to claim 26, comprising:
comparing the accumulated usage with a usage limit stored on the memory module; and
disabling, at least partially, a storage functionality of the memory module based on a result of the comparing.

28. The method according to claim 27, comprising:
providing lessee with a usage extension code for changing the usage limit information.

29. The method according to claim 28, wherein the providing lessee with the usage extension code is performed via a computer network.

30. The method according to claim 28, wherein monitoring the accumulated usage, comparing the accumulated usage with the usage limit, and providing lessee with the usage extension code are performed automatically.

31. The method according to claim 25, wherein the accumulated usage is an accumulated usage time of the memory module.

32. A method of leasing a memory module, comprising:
providing the memory module to a lessee for usage in a computer;
disabling, with a control unit of the memory module, at least partially, a storage functionality of the memory module if a pre-determined usage limit is exceeded;
providing, with a server, a usage extension code to the computer via a data transfer connection between the computer and the server; and
increasing the pre-determined usage limit based on the usage extension code.

33. The method according to claim 32, comprising:
automatically requesting, with the computer, the usage extension code from the server via the data transfer connection as the pre-determined usage limit is approached.

34. The method according to claim 33, comprising:
automatically transmitting, with the computer, identification information identifying the memory module to the server via the data transfer connection; and
wherein the usage extension code is provided based on the identification information.
